(19) United States
(12) Patent Application Publication
(10) Pub. No.: US 2015/0019605 A1
(43) Pub. Date: Jan. 15, 2015

(54) Method for assessing an output of a random number generator

(71) Applicant: Eberhard BOEHL, Reutlingen (DE)

(72) Inventor: Eberhard BOEHL, Reutlingen (DE)

(73) Assignee: Robert Bosch GmbH, Stuttgart (DE)

(21) Appl. No.: 14/325,585

(22) Filed: Jul. 8, 2014

(30) Foreign Application Priority Data
Jul. 9, 2013 (DE) 10 2013 213 392.8

(51) Int. Cl. G06F 7/58

(52) U.S. Cl. CPC G06F 7/588; G06F 2207/58
USPC 708/250

(57) ABSTRACT

A method for assessing an output of a random number generator which is provided by two phase-locked loops of the random number generator includes: receiving, by a checking system, the output of the random number generator for at least two sampling cycle, wherein for each sampling cycle (i) the output of the random generator includes a sequence of sample values between a starting value and an end value, and (ii) all sample values between the starting value and the end value in the respective cycle are entered into a signature; and comparing, by the checking system, the signatures from the at least two sampling cycles to one another.

### BACKGROUND OF THE INVENTION

1. Field of the Invention

The present invention relates to a method for checking an output of a random number generator and a system for carrying out the method.

2. Description of the Related Art

Random numbers, referred to as the result of random elements, are necessary for numerous applications. So-called random number generators are used to generate random numbers. Random number generators are processes which supply a sequence of random numbers. A crucial criterion of the quality of random numbers is whether the result of the generation may be regarded as independent of earlier results.

Random numbers are necessary for cryptographic processes, for example, and are used to generate keys for these encryption processes. Random number generators (RNGs) are used, for example, to generate master keys for symmetrical encryption processes and protocol handshaking in elliptical curve cryptography (ECC), which prevent attacks of performance analysis and replay attacks.

There are two basic types of RNGs, the first being pseudo-random number generators (PRNGs) for high throughputs and low security levels. In a PRNG, a secret value is usually input, and each input value will always result in the same output sequences. However, a good PRNG will output a number sequence which appears to be random and which passes most tests.

Stringent requirements regarding the random characteristics are imposed on keys for cryptographic processes. For this reason, pseudo-random number generators (PRNGs), represented by a linear feedback shift register (LFSR), for example, are not suitable for this purpose. Only a generator of true random numbers, referred to as a true random number generator (TRNG), meets the imposed requirements. The true random number generator makes use of natural noise processes in order to obtain a nonpredictable result. Noise generators which make use of the thermal noise from resistors or semiconductors, i.e., the shot noise at potential barriers, for example at pn transitions, are common. Another option is the utilization of the radioactive decay of isotopes.

Whereas the “classical” methods use analog elements such as resistors as noise sources, digital elements such as inverters are being used more frequently in recent times. These digital elements have the advantage of a less complicated circuit layout, since they are present as standard elements. In addition, such circuits may also be used in freely programmable circuits such as FPGAs.

One known method uses phase-locked loops (PLLs) which are able to generate from a predefined signal frequency the multiple of this frequency for a random number generator.

The publication “A Simple PLL-Based True Random Number Generator for Embedded Digital Systems” by Drutarovsky, M. et al. (Computing and Informatics, Vol. 23, 2004, 501-515) describes how a random source may be established by using two PLLs. The two PLLs generate two output clock pulse signals CLK and CLJ, having different frequencies, from a shared input clock pulse CU by selecting the configurable frequency multiplication parameters of the two PLLs to be different.

The publication “Model of a True Random Number Generator Aimed at Cryptographic Applications” by Simka, M. et al. (ISCAS 2006) describes a “quasi-periodic” signal which results when a higher-frequency deterministic clock pulse signal CLK is sampled using a lower-frequency clock pulse signal CLJ (both obtained with the aid of one PLL each) which is provided with a jitter. If no jitter is present, the output signal is perfectly periodic. If a jitter is present, the successive periods are not identical, but differ only by a few random sample values, while the main part of the samples remains unchanged.

Using the multiplication values K_{M} and K_{D}, which are respective divisors in the feedback of the two PLLs and which are preferably prime numbers relative to one another, a cycle having period T_{Q} is present for which the following applies:

T_{Q}=K_{D}T_{CLK}=K_{M}T_{CLJ}

This means that after K_{D} clock pulses of sampling clock pulse T_{CLK}, the sampling takes place at the same position of random clock pulse T_{CLJ}.

The multiplication values or factors are integer values which correspond to an integer divisor value in the feedback of the PLL.

In the publication “Model of a True Random Number Generator Aimed at Cryptographic Applications,” a method is presented via which the randomness in the circuit may be measured using the PLLs. For this purpose, all samples are stored in a cycle (1), re-sorted, and the ones in each sample are summed over Q cycles in K_{D} accumulators. The re-sorting takes place in such a way that the samples i=0, 1, 2, . . . K_{D-1} are arranged according to an index j, where

j=iK_{M}mod K_{D}

In the stated examples, values of 207 or 175 for K_{D} are given when K_{M}=212 or 516, respectively, and Q=1000.

Each accumulator is designed to then count the number of ones, and at the end an average value is formed in each case. For the stated examples, each accumulator should have at least 10 or 12 bits, so that 10*207=2070 or 12*175=2100 memory elements, respectively, are necessary. This would mean an outlay of 16,800 gates, taking only the storage of data into account (if the memory had been implemented using registers), but not the implementation of the average value formation, the control, and the evaluation.

Alternatively, storage in a RAM is of course also possible. However, a high outlay still remains: 2 to 4 kBytes RAM, depending on the organization, and a corresponding control/evaluation logic system. This level of complexity is excessive, and should be significantly reduced.

### BRIEF SUMMARY OF THE INVENTION

The presented method is suitable when sufficient PLLs are present in FPGAs, and for ASICs the outlay for a PLL is rather small. This may be applicable for the surface area outlay and the power consumption. However, the dependency of analog components of a PLL on technology should be noted.

By use of the presented system, an online test of the entropy in a TRNG source is possible using a checking device, and the complexity is significantly reduced compared to the method according to the related art.

In the method, a multiple input signature register (MISR), for example, is used which forms a unique signature from a sequence of input bits, and which thus represents a unit for forming a signature from a sequence of sample values. If two output signatures are different from one another, it may be concluded that the input bit sequences which have been input for generating the signatures are likewise different from one another. The same sequence of input bits forms the same signature. A “signature” is not understood to mean a digital signature in the sense of security requirements which are used as authentication and intended to prevent counterfeiting, but, rather, only a property of the bit sequence, which in the present case is ascertained with the aid of an MISR.

Further advantages and embodiments of the present invention result from the description and the appended drawings.

It is understood that the features stated above and to be explained below may be used not only in the particular stated combination, but also in other combinations or alone without departing from the scope of the present invention.

### BRIEF DESCRIPTION OF THE DRAWINGS

FIG. 1 shows one embodiment of a PLL-based TRNG source.

FIG. 2 shows one embodiment of a system for carrying out the method.

FIG. 3 shows one embodiment of the presented method in a flow chart.

FIG. 4 shows another system for carrying out the method.

FIG. 5 shows a random source together with a checking device.

FIG. 6 shows one embodiment of the method in a flow chart.

### DETAILED DESCRIPTION OF THE INVENTION

The present invention is schematically illustrated in the drawings based on specific embodiments, and is described in greater detail below with reference to the drawings.

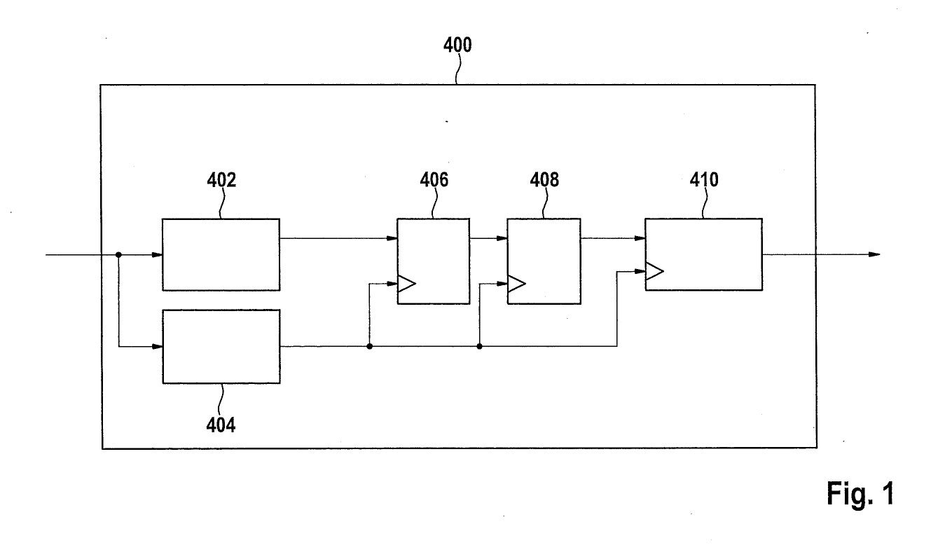

FIG. 1 shows a TRNG source 400 having two phase-locked loops (PLLs) 402, 404, two flip-flops 406, 408, and a decimator 410 which antivalently links the bits of one or multiple cycles and thus implements a bit-by-bit XOR. First flip-flop 406 may also be dispensed with if the metastability does not represent a problem. TRNG source 400 shown may be used in a circuit system or together with a system for carrying out the presented method.

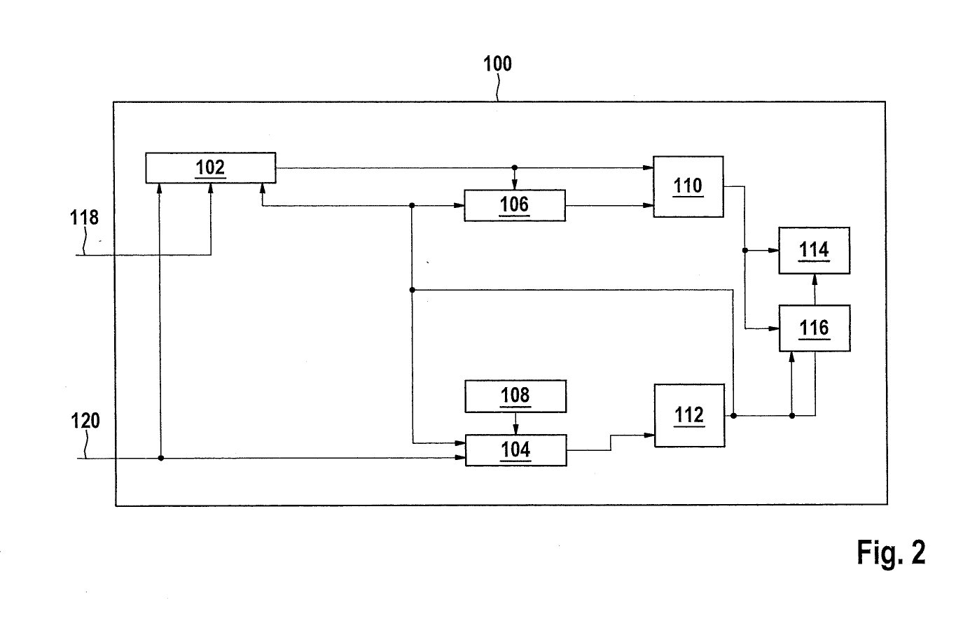

FIG. 2 shows a system 100 which is used as a checking system for carrying out the presented method. System 100 includes an MISR 102, a sampling counter 104, a signature register memory 106, a sampling counter default register 108, a comparator 110, a zero detector 112, an entropy counter 114, and a warning counter 116. There is also a first input 118 for an input signal and a second input 120 for a start signal.

System 100 uses the output signal of second flip-flop 408 from FIG. 1 as the input signal at first input 118, which is to be checked for random characteristics.

Corresponding to the principle of the TRNG source according to the cited publications, the two PLLs 402, 404 are supplied using a shared clock pulse, and are characterized by different divisor values in the feedback, and thus by different frequency multiplication factors. If possible, factors K_{M} and K_{D} should have a largest common divisor of 1. The maximum length of a cycle is then achieved until the same conditions once again occur during the sampling. This length of a cycle corresponds to number K_{D}. In a period of K_{D} samplings, clock pulse CLJ has exactly K_{M} clock pulse periods when K_{M} is an integer value. Even when the two factors have a common divisor greater than 1, after a number of K_{D} clock pulse periods a cycle is terminated as long as K_{M} is an integer value. However, this cycle is then composed of multiple partial cycles.

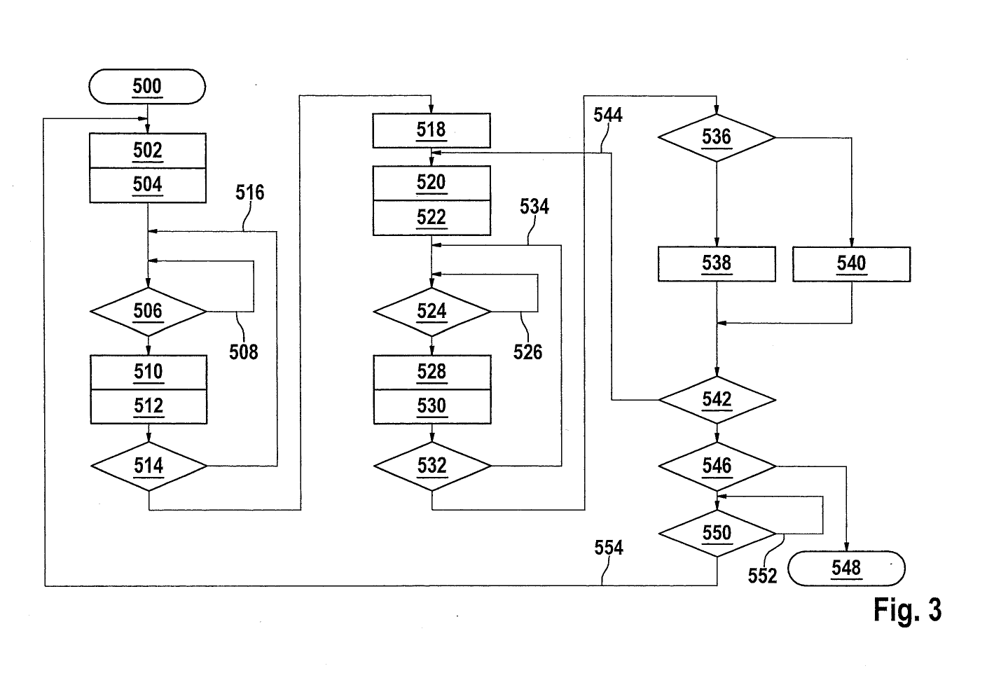

Circuit system 100 from FIG. 2 and the sequence illustrated in FIG. 3 are provided as examples of checking of the random component:

The start takes place in a step 500. The MISR is subsequently set equal to 0 in a step 502. The sampling counter is then set equal to Kₙ in a step 504.

A check is made in a next step 506 as to whether a new sampling is present. If this is not the case, this step is repeated (arrow 508). If this is the case, the sampling counter is decremented in a step 510. The input value is entered into the signature of the MISR in a step 512. “Entering” is understood to mean that the input signals are XOR-linked to the output values of the flip-flops of the MISR at various points of the MISR, these linked signals are used as input signals of a different flip-flop of the MISR, and a shift operation having an appropriate feedback function is subsequently carried out. Such an operation is known in principle.

A check is subsequently made in a step 514 as to whether the sampling counter is equal to 0. If this is not the case, the method goes back (arrow 516). If this is the case, the signature generated in the MISR is stored in the signature register in a step 518. The MISR is set equal to 0 in a next step 520. The sampling counter is set equal to Kₙ in a step 522. A check is subsequently made in a step 524 as to whether a new sampling is present. If this is not the case, this step is repeated (arrow 526). If this is the case, the sampling counter is decremented in a step 528, and the input value enters into the signature of the MISR in a step 530.

A check is subsequently made in a step 532 as to whether the sampling counter is equal to 0. If this is not the case, the method goes back (arrow 534). If this is the case, a check is then made in a step 536 as to whether the signature register corresponds to the MISR. If this is the case, the warning counter is incremented in a step 538. If this is not the case, the entropy counter is incremented in a step 540.

A query is subsequently made in step 542 as to whether the method should be continued. If this is the case, a skip is made to step 520 (arrow 544). If this is not the case, a query is made in a step 546 as to whether the method should be restarted. If this is not the case, the method is terminated with step 548. If this is the case, a query is made in a step 550 as to whether a new sampling is present. If this is not the case, step 550 is repeated (arrow 552). If this is the case, the method is restarted with step 502 (arrow 554).

The sequence may be summarized as follows:

1. Set a counter (104) to a default value, for example K_{D}, and set an MISR 102 to a starting value; for example, all memory elements are set equal to 0.

2. With each subsequent sampled value, counter 104 is decremented, and at the same time the sample values are entered into a signature (MISR 102).

3. When the counter has reached the value 0, store the MISR value in a register.

4. Set counter 104 to the default value, and reset MISR 102 to the starting value.

5. With the next and each subsequent sampled value, counter 104 is decremented, and at the same time the sample values are entered into the signature (MISR 102).

6. When counter 104 has reached the value 0, compare the signature to the stored value, using the comparator 110:

a) If the signature value is different: increment an entropy counter 114.

b) If the signature value is the same: increment a warning counter 116.

7. Either go to state 4, or go to state 1 after reaching a new starting value.

The skip to point 4 or point 1 may be made as a function of the particular values in the entropy counter and the warning counter, or a fixed number of sequences having the same starting value may also be predefined. After a predefined time period, the two assessment counters 114, 116 may be compared to setpoint values, and a random value and thus the quality of the TRNG source may be determined therefrom.

The outlay for system 100 is significantly lower than for systems according to the related art. If 10 bits each are used for sampling counter 104, register 108, and counters 114 and 116, and 16 bits each are used for MISR 102 and register 106, 72 bits memory capacity is necessary. This is only 72/2100=3.4% of the outlay for memory bits compared to the related art. The combinatory outlay is correspondingly reduced.

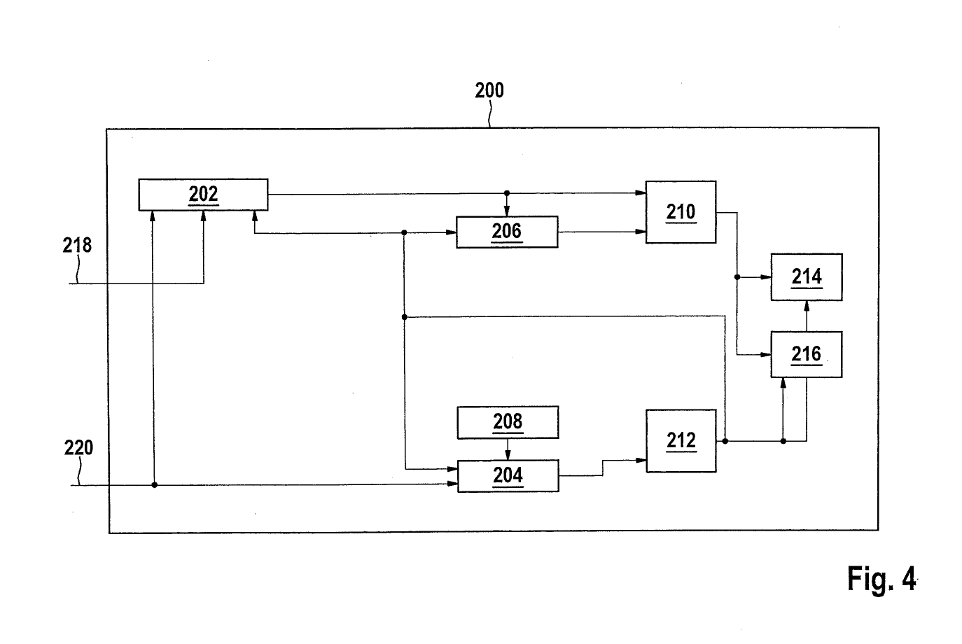

FIG. 4 shows another specific embodiment of the system, which is provided overall with reference numeral 200. The illustration shows an edge counter 202, a sampling counter 204, an edge counter memory 206, a sampling counter default register 208, a difference former 210, a zero detector 212, an entropy counter 214, and a warning counter 216. In addition, a first input 218 for an input s0 and a second input 220 for a start signal are provided.

To assess the random characteristics even more accurately, instead of forming a signature in MISR 102 from FIG. 2, the number of ones or the number of transitions in edge counter 202 may be counted. This value is stored in a memory 206, and after the comparison cycle is completed, the difference between edge counter 202 and edge counter memory 206 is formed in difference former 210.

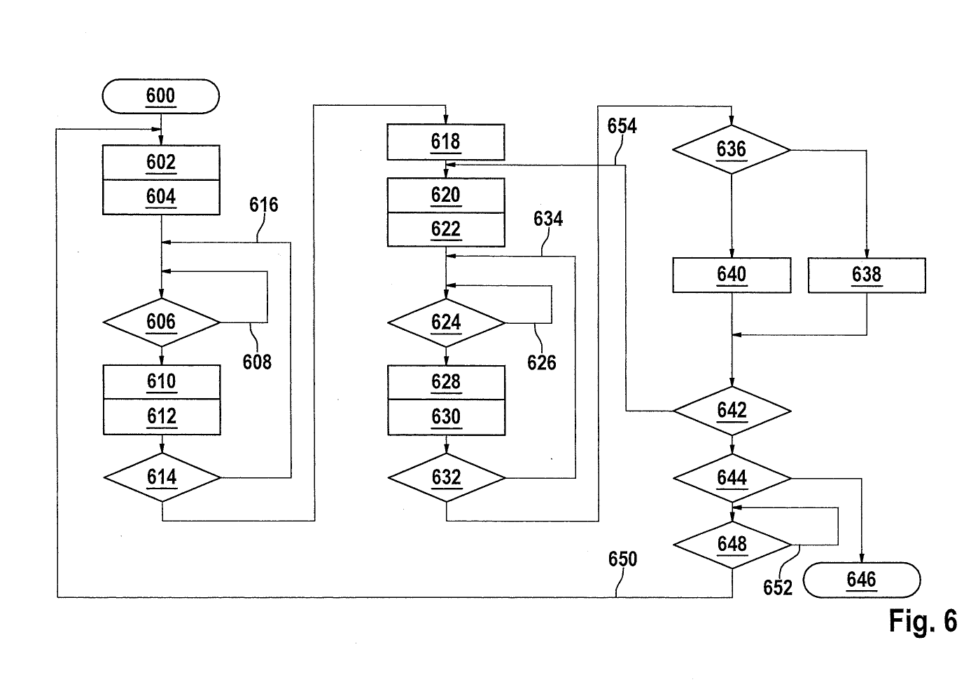

If the difference is equal to 0, warning counter 216 is incremented, and in the other case, the difference value is added to entropy counter 214. In this regard, reference is made to the flow chart shown in FIG. 6. More accurate information is thus obtained regarding the changes in two cycles, and thus regarding the rate of randomness.

In another generalization, the number of ones in the output signal in one period may be counted and compared to the number of ones in at least one additional period.

For an output signal sequence, the number of ones, the number of 0-1 transitions and of the 1-0 transitions, or the signature, which are formed with the aid of an MISR, are properties of the signal pattern. If one bit in this signal pattern is interchanged with the inverse value, this will typically have an impact on these properties. Thus, for example, a different signature is generated when one bit changes; the number of ones changes, and the number of transitions may also change. It is not absolutely necessary for the property to change for each change in the signal pattern, since during testing of the properties it is not necessary to actually recognize all changes. It is only necessary to recognize a minimum number of changes, and thus, a lower limit of the degree of randomness. Therefore, for example, when the number of transitions does not change when one bit in the signal pattern changes, this may be disregarded. In addition, the bit rate of signature register MISR does not have to be selected to be large enough that two different signal patterns are not able to bring about the same signature, which is referred to as “aliasing.” Therefore, as a function of the length of the signal sequence, a small signature width is sufficient to be able to establish a minimum degree of randomness.

The maximum number of constant signal values which follow one another in direct succession after zeros or ones, the occurrence of a 0-1-0 or a 1-0-1 transition, or the length of a sequence having constantly changing signal values may be considered as further properties. The values of the entropy counter and of the warning counter are checked at certain intervals and compared to setpoint values. These counters are subsequently reset. A certain degree of randomness may be determined from the values of the counters.

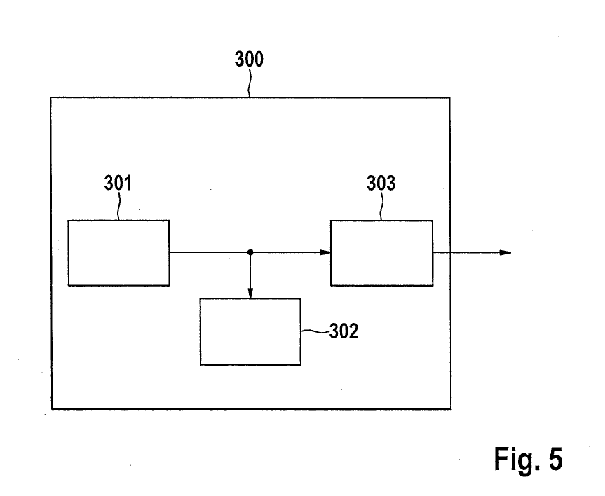

FIG. 5 shows a circuit system 300 for carrying out the described method, via which an online test of the entropy on a TRNG source 301 is possible, using a checking device 302. The complexity is significantly reduced compared to the method according to the related art.

FIG. 6 shows another possible sequence of the method, having an edge counter. The start takes place in a step 600. The edge counter is set equal to 0 in a next step 602, and the sampling counter is then set equal to Kₙ in a step 604. A check is subsequently made in a step 606 as to whether a new sampling is present. If this is not the case, this step is repeated (arrow 608). If this is the case, the sampling counter is decremented in a step 610. In a step 612 the edge counter is then incremented by the number of edges that are present.

A check is subsequently made in a step 614 as to whether the sampling counter is equal to 0. If this is not the case, the method returns to step 606 (arrow 616). If this is the case, the edge counter is stored in the edge counter register in a step 618. The edge counter is then set equal to 0 in a step 620, and the sampling counter is set equal to Kₙ in a step 622.

A check is subsequently made in a step 624 as to whether a new sampling is present. If this is not the case, the step is repeated (arrow 626). If this is the case, the sampling counter is decremented in a step 628. In a step 630 the edge counter is then incremented by the number of edges that are present.

A check is subsequently made in a step 632 as to whether the sampling counter is equal to 0. If this is not the case, a skip is made to step 624 (arrow 634). If this is the case, a check is made in a step 636 as to whether the edge counter register corresponds to the edge counter. If this is not the case, the entropy counter is incremented in a step 638. If this is the case, the warning counter is incremented in a step 640.

A query is subsequently made in a step 642 as to whether the method should be continued. If this is not the case, a query is made in a step 644 as to whether the method should be carried out anew. If this is not the case, the method is terminated in a step 646. If this is the case, a check is made in a step 648 as to whether a new sampling is present. If this is the case, the method goes back (arrow 466). If this is not the case, a return is made to the start (arrow 650). Otherwise, the step is repeated (arrow 652). If the result of the query in step 642 indicates that the method should be continued, the method goes back (arrow 654).

Moreover, a circuit system is presented which in the embodiment includes a random source and a checking system, as illustrated in FIGS. 2 and 4, for example, and which is characterized in that the random source periodically outputs data having a constant number of random values, and the checking device generates and stores properties of the output signal of the random source in such a period and compares same to the properties of this output signal in at least one additional period.

The signal values of the output signal may be entered into a signature, and for this purpose are linked in a multiple input signature register, for example.

It may be provided that the number of ones in the output signal is counted. Alternatively, it may be provided that the number of signal transitions in the output signal is counted.

A first counter may be incremented when the properties of the output signal are the same. When the properties of the output signal are not the same, a second counter may be incremented, or increased by a value which results from the difference between the properties.

The first counter and/or the second counter is/are typically used for assessing the properties of the TRNG source.

What is claimed is:

1. A method for assessing an output of a random number generator which is provided by two phase-locked loops of the random number generator, comprising:
receiving, by a checking system, the output of the random number generator for at least two sampling cycle, wherein for each sampling cycle (i) the output of the random generator includes a sequence of sample values between a starting value and an end value, and (ii) all sample values between the starting value and the end value in the respective cycle are entered into a signature; and
comparing, by the checking system, the signatures from the at least two sampling cycles to one another.

2. The method as recited in claim 1, wherein the signatures are formed by a multiple input signature register.

3. The method as recited in claim 1, wherein the signatures are formed by a counter which counts transitions of bit values which form the signatures.

4. The method as recited in claim 1, wherein the signatures are formed by a counter which counts the number of ones in bit values which form the signatures.

5. The method as recited in claim 1, wherein an entropy counter is incremented when the at least two signatures are different.

6. The method as recited in claim 1, wherein a warning counter is incremented when the at least two signatures are the same.

7. The method as recited in claim 5, wherein post-processing is carried out after the checking.

8. A system for assessing an output of a random number generator which is provided by two phase-locked loops of the random number generator, comprising:
a signature forming system which receives the output of the random number generator for at least two sampling cycle, wherein for each sampling cycle (i) the output of the random generator includes a sequence of sample values between a starting value and an end value, and (ii) all sample values between the starting value and the end value in the respective cycle are entered into a signature by the signature forming system; and
a comparator for comparing the signatures from the at least two sampling cycles to one another.

9. The system as recited in claim 8, further comprising:
an entropy counter which is incremented when the at least two signatures are different; and
a warning counter which is incremented when the at least two signatures are the same.
